(19) United States
(12) Patent Application Publication
(10) Pub. No.: US 2009/0281925 A1
(43) Pub. Date: Nov. 12, 2009

(54) COLOR MATCH TOOLBOX

(75) Inventors: Alexandre Winter, Washington, DC (US); Frederic Jahard, Vincennes (FR)

Correspondence Address: MICHAUD-DUFFY GROUP LLP, 306 INDUSTRIAL PARK ROAD, SUITE 206, MIDDLETOWN, CT, 06457, US

(73) Assignee: LTU Technologies S.A.S., Paris (FR)

(21) Appl. No.: 12/463,773

(22) Filed: May 11, 2009

Related U.S. Application Data
(60) Provisional application No. 61/051,953, filed on May 9, 2008.

(51) Int. Cl. G06Q 30/00; G06F 17/30

(52) U.S. Cl. 705/27; 707/3; 707/E17.108

(57) ABSTRACT

A system and method is presented for identifying a plurality of products within a collection of product images in an online shopping environment. The method includes providing the collection of images representing products offered for sale; receiving an input search criteria from a prospective customer. The criteria include at least one of a query color. The method also includes identifying and extracting colors within the collection of images based on a presence of significant colors in an image; and comparing and matching the query color to the identified and extracted significant colors. The method continues by determining, within a predetermined range of accuracy, products from within the collection of images having the matched query color; and presenting the determined products to the prospective customer. In one embodiment, the presentation is provided by means for a graphical user interface.

### CROSS-REFERENCE TO RELATED APPLICATIONS

This patent application claims priority benefit under 35 U.S.C. § 119(e) of copending, U.S. Provisional Patent Application Ser. No. 61/051,953, filed May 9, 2008, the disclosure of this U.S. patent application is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

This invention relates generally to systems and methods for assisting consumers in the online selection and purchase of merchandise and, in particular, to systems and methods for executing color based queries to identify and present related merchandise within collections of online merchandise offerings to prospective consumers.

2. Description of Related Art

One of the challenges for online shopping service providers is to offer a shopping experience as exciting and enjoyable online as in offline shopping experience, e.g., shopping in brick and mortar stores. For example, color is often a significant feature in many real life shopping experiences. Seeing, for example, sample cloths or arrangements of trendy colors on the shelves or in the windows of a store, or finding the “perfect” color of a new item that matches the color of one or more items already purchased, are a large part of the offline shopping experience.

By comparison, online shopping does not yet offer the same array of sensorial experiences as are typically associated with offline shopping such that some of the “fun in buying” is lost. For example, in the offline world a prospective consumer searches an inventory of items presented in a retail environment for items of interest, selects a few items for review and comparison, and then, decides which, if any, to purchase. The prospective consumer searches and selects items of interest according to how well the item fits the consumer physically (e.g., size), economically (e.g., is the item reasonably priced, can the consumer afford the item, and the like) and also how well the items matches previously purchased items in terms of, for example, a same or complimentary color, style, and the like.

Some color based search functions have been deployed recently on some electronic commerce/shopping search engines such as, for example, a “www.like.com” website. Most entities that provide an online shopping environment request that they be provided an ability to offer their customers a function for executing “color queries.” A color based query would, for example, enable shoppers to select a color and look for items containing that color within a retailer's online catalog. However, the inventors have found that these conventional color based search functions do not yet match the offline experience. Moreover, the inventors have recognized that a need exists for tools to assist in the identification and selection of related merchandise within collections of online merchandise offerings to prospective consumers.

Based on the foregoing, the present invention provides systems and methods for enhanced color based queries of product collections to assist prospective consumers locate desired merchandise.

### SUMMARY OF THE INVENTION

The present invention resides in one aspect in a computer executed method for identifying a plurality of products within a collection of products in an online shopping environment. The method includes providing a collection of images representing the collection of products offered for sale; receiving an input search criteria from a prospective consumer, where the input search criteria including at least one query color. The method further includes identifying and extracting colors within the collection of images based on a presence of significant colors in an image; comparing and matching the query color to the identified and extracted significant colors; and determining, within a predetermined range of accuracy, products from within the collection of images having the matched query color. The method also includes presenting the determined products to the prospective customer.

In another aspect, the invention provides a system for identifying a plurality of products within a collection of products in an online shopping environment. The system includes a collection of images representing the collection of products offered for sale; an interface including an input search criteria portion that receives at least one query color; a collection palette processor for identifying and extracting colors within the collection of images based on a presence of significant colors in an image; a color search processor for comparing and matching the query color to the identified and extracted significant colors, and for determining, within a predetermined range of accuracy, products from within the collection of images having the matched query color; and a display device coupled to the color search processor for presenting the determined products to the prospective customer.

### BRIEF DESCRIPTION OF THE DRAWINGS

FIG. 1 is a simplified schematic block diagram of a Color Swatch Toolbox system providing enhanced color based queries of online product collections in accordance with one embodiment of the present invention;

FIGS. 2A-2D depict exemplary photo palettes providing graphic representations of colors extracted from a product image;

FIGS. 3A-3D depict exemplary collection palettes providing graphic representations of colors extracted from collections of product images;

FIG. 4 depicts one embodiment of a user interface provided by the Color Swatch Toolbox system to a prospective consumer to initiate a color based search of a collection of product images and to evaluate the results of the search;

FIG. 5 depicts another embodiment of the user interface of FIG. 4;

FIG. 6 is a schematic block diagram of a process for inputting an image to drive a color based query according to one aspect of the invention;

FIG. 7 depicts a portion of the user interface of FIG. 4 illustrating a process for providing suggested colors to the prospective consumer.

### DETAILED DESCRIPTION OF PREFERRED EMBODIMENTS

In one aspect of the present invention, system and methods are presented for providing a Color Swatch Toolbox system having computer-implemented algorithms including:

a photo palette algorithm that extracts colors presented in an image.

a collection palette algorithm that extracts colors of all objects (e.g., clothing and portions thereof) in a collection such as, for example, an online clothing catalog of a retailer or collection of two or more retailers, and extracts significant colors within the collection.

a color search algorithm that searches for items in a collection that contain at least one color that is the same, substantially the same, or close to (within a predetermined threshold) at least one query color inputted by a party.

a matching palette algorithm that extracts all colors that are present in the items (e.g., clothing and portions thereof) found using the color search. Accordingly, colors matching the at least one query color are identified on the objects within the collection and the object is presented and/or recommended to the party.

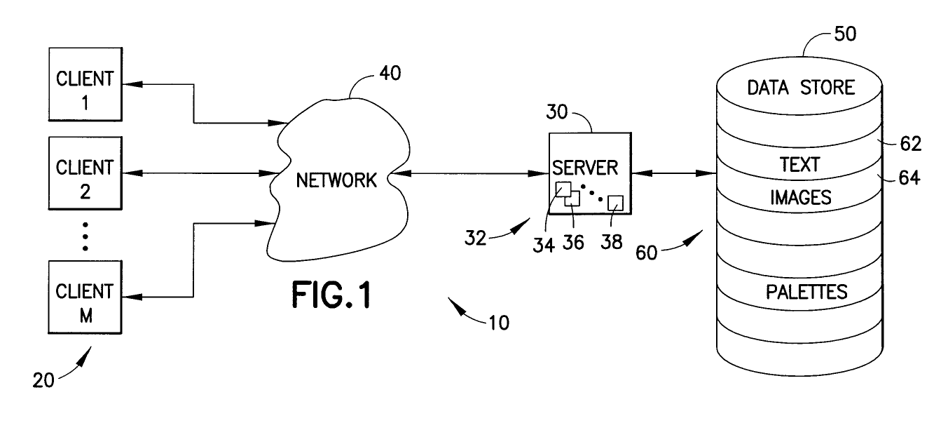

As shown in FIG. 1, an exemplary implementation of the Color Swatch Toolbox system 10 is provided as computer-implemented algorithms executing steps on one or more general purpose computers, work stations, and portable computing devices such as, for example, a personal digital assistant (PDA), laptop computer or the like. In FIG. 1, the Color Swatch Toolbox system 10 includes a plurality of client devices (e.g., Client 1-M), shown generally at 20, operative coupled to a server device 30 over a communication network 40 such as, for example, the Internet, an intranet, an extranet, or like distributed communication platform connecting computing devices over wired and/or wireless connections. As is known to those skilled in the art, the client devices 20 and server 30 each include a processor, computer-readable medium or memory, and input-output devices including devices for facilitating communication over the network 40. The processor executes program instructions stored in the memory such that clients operating individual ones of the client devices 20 communicate over the network 40 with other client devices 20 as well as other computing devices coupled to the network, such as the server device 30. It should be appreciated that the client devices 20 include, for example, a personal computer (PC), workstation, laptop, tablet computer, personal digital assistant, pocket PC, Internet-enabled mobile radiotelephone, pager or like portable computing devices.

As shown in FIG. 1, the server 30 is coupled to a data store 50. It should be appreciated that the data store 50 may be a relational data base, object oriented data base or other suitable data repository, as is known in the art. In one embodiment, the data store 50 stores one or more catalogs of merchandise including text 62 and/or photographs 64 of the merchandise, e.g., online catalog of home goods, furniture, shoes and/or other articles of clothing of an online shopping retailer. As is generally known in the art, the data store 50 stores electronic data files, shown generally at 60, the content of which, in accordance with one embodiment of the present invention, relates to the online catalogs that are accessible to prospective consumers operating one of the client devices 20 by connecting to the server 30. For example, the server 30 hosts user interface such as a home page and other web pages, shown generally at 32, that are requested by the prospective consumers through designation of a Uniform Resource Locator (URL) identifying the web pages 32 and providing access to the server 30 from other computing devices on the network 40. In one embodiment, access to the web pages 32, server 30, the data store 50, selected portions thereof, and/or to selected services and functionality provided by the system 10, is restricted to registered (e.g., “member”) consumers and others, as is described below. The client devices 20 execute programs such as, for example, web browser software to request, receive and process the web pages 32. The web pages 32 are generally written in a language that permits a graphical presentation of information (text, images, audio, video, and the like) to persons operating a computing device. Languages include for example, the Hyper-Text Markup Language (HTML), Extensible Markup Language (XML) or another Standard Generalized Markup Language (SGML), as are generally known in the art.

When requested, the server 30 transmits a file to a requesting one of the client devices 20 via a file transmission protocol (e.g., FTP, TCP/IP, or like protocols). The file may have links, pointers, or other resources including images, graphics, audio or video streams, for presenting information on the web browser executing on the requesting client devices 20. As disclosed herein, the information stored in the data store 50 in the form of electronic data files 60 includes, for example, text files 62, and photographs or other image files 64, and the like, as well as search results (e.g., collection palettes, described below).

It should be appreciated that it is within the scope of the present invention for the computing devices described above as being networked to broadly define all standalone as well as networked computing devices operatively coupled over wired and/or wireless communication networks as is known in the art. As is generally known, each of the computing devices may include a central processing unit (CPU), computer readable memory for storing the algorithms, process variables and data for executing the algorithms, and a display device such as, for example, a pixel-oriented display device for exhibiting results of the algorithms including, for example, visual representations of objections within an online clothing catalog or collection. It should also be appreciated that the computer-implemented steps generally require manipulation of data in the form of electrical, magnetic and/or optical signals that may be stored, transferred, combined, compared, or otherwise manipulated to provide a desired result. In one embodiment, a desired result includes visual representations of one or more clothing objects within the collection of objects that include a color that matches, within a predetermined threshold, an inputted query color.

As noted above, in one embodiment, the Color Swatch ToolBox system 10 includes the photo palette algorithm. The photo palette algorithm, also referred to as a photo color summary algorithm, combines color-space and pixel-space iterative dilation and performs clustering to identify color clusters that are coherent both in the color space and the geometric space. As described herein, the photo color summary algorithm iteratively clusters a color histogram of an image (e.g., image of an article of clothing) until a limited number of clusters remain and their average colors are then used to describe the image. In a first step, the photo palette algorithm detects the colors that are the most present colors in an image (e.g., dominant colors based on frequency of occurrence in the image) from a color histogram of the image. Each color is then represented as a map of its presence in the image space. The map is then dilated using mathematical morphology, and a resulting mask is intersected with the mask corresponding to the spatial representation of the colors that are within a given range of the original color cluster. This is a color controlled morphological dilation of the original mask.

This operation is performed for each cluster until all the pixels of the image are assigned to a cluster. Once all the clusters are created, if there are too many clusters, the clusters are merged on a color/space distance basis. For example, two clusters are merged if they are spatially close and if their representative colors are close enough in the color space (e.g., as determined within a predetermined threshold). The operation is repeated until the desired number of colors and/or clusters (e.g., within predetermined numbers) is reached. Once the final number of clusters is within a predetermined range, the system returns for each cluster its coordinates in a chosen color space, e.g. red, green and blue (RGB) or hue, saturation and value (HSV), of the central color and the percentage (and/or absolute number) of pixels that are attached to this cluster within the original image. As can be appreciated, in one embodiment, the original image can have its background segmented from the foreground by a segmentation algorithm such as a Differential Feature Distribution Map (DFDM) algorithm described in a commonly assigned U.S. Provisional Patent Application Ser. No. 61/048,695, so as not to capture the background colors.

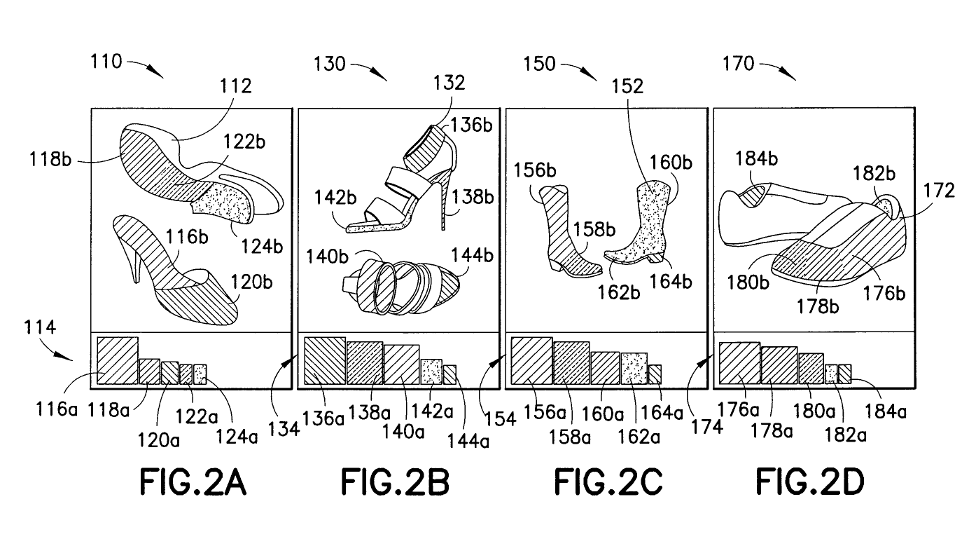

FIGS. 2A-2D illustrate examples of photo palettes 110, 130, 150 and 170 extracted from a catalog of women's shoes by the photo palette algorithm. Each color detected in pairs of shoes 112, 132, 152, and 172, respectively, by the photo palette algorithm is represented by a series of graphic representations 114, 134, 154 and 174 of the colors found in the shoes, for example, squares where one square is provided for each color detected in the image of each of the shoes. For example, series 114 including five squares 116a, 118a, 120a, 122a and 124a representing five colors 116b, 118b, 120b, 122b and 124b detected in the pair of shoes 112, series 134 including five squares 136a, 138a, 140a, 142a and 144a representing five colors 136b, 138b, 140b, 142b and 144b detected in the pair of shoes 132, series 154 including five squares 156a, 158a, 160a, 162a and 164a representing five colors 156b, 158b, 160b, 162b and 164b detected in the shoes 152, and series 174 including five squares 176a, 178a, 180a, 182a and 184a representing five colors 176b, 178b, 180b, 182b and 184b detected in the shoes 172. In one embodiment, a surface area of each graphic representation (e.g., square) within the series is proportionate to a percentage of the subject color present in the object (e.g., shoes). For example, as shown in FIG. 2B, a dark brown color 136b dominates the pair of shoes 132 as is apparent from the surface area of graphic representation, e.g., square 136a, representing the dark brown color 136b, which is larger than the other squares 138a, 140a, 142a and 144a. It should be appreciated that while the series of graphic representations 114, 134, 154 and 174, are illustrated as squares, it is within the scope of the present invention to employ any geometric shape such as, for example, circles, bar or column shapes, and the like. Moreover, the series of graphic representations 114, 134, 154 and 174 may include and/or be represented by a numeric amount and/or percentage indicating the percentage or dominance of the subject color detected within a subject image.

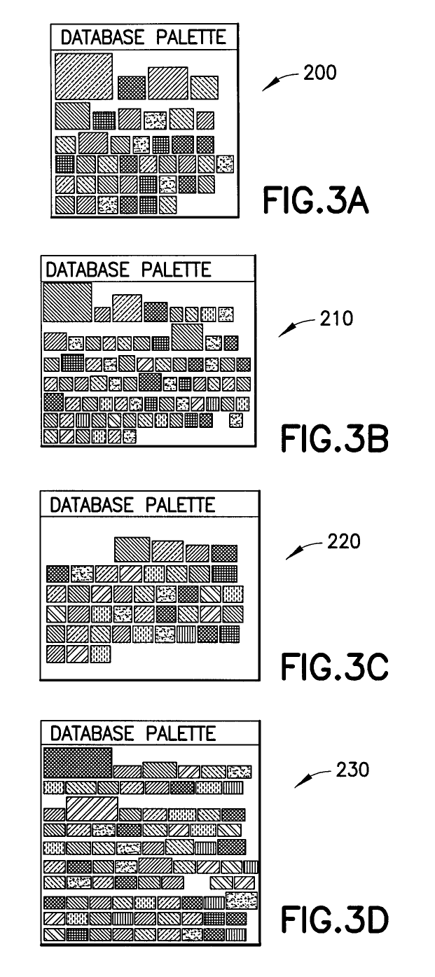

As disclosed herein, color extraction methods are used to compute the palette or color summary of a catalog of photographs of objects, e.g., online catalog of merchandise including furniture, housewares, shoes and/or other articles of clothing of an on-line shopping retailer. Using the Photo Palette algorithm described above, or any other color extraction algorithm, the Collection Palette algorithm starts by extracting the principal colors as well as their percentages of presence, for each of the images of the collection. Once the colors are extracted, a set of principal colors and presence percentages are processed so as to merge the statistics for all extracted colors and to compute a set of unique colors with their total presence counters. Referring again to FIGS. 2A-2D, a collection palette is built from the women's shoes 112, 132, 152, and 172. As should be appreciated, the collection palette is initially empty. For each color in the collection, the Collection Palette algorithm first checks if the color is present in the collection palette, or a color close enough to it (within a predetermined threshold). If not, the color is added to the collection set with its current presence percentage. If the color is already present in the set, the presence percentage of the color is incremented to include the presence percentage of the current entry. This process is repeated until all the colors have been added or incremented within the collection palette. At this point, an additional and optional step of clusterization simplifies the collection set even more. For example, if the palette has to be of a predetermined size such as a size of n colors, the n colors with the n highest percentage presence counters of the collection palette set are extracted, and these n colors form the palette of the collection. FIGS. 3A-3D illustrates collection palettes for a number of online catalogs including a Collection Palette 200 for a collection of women's shoes (FIG. 3A), a Collection Palette 210 for a collection of children's clothes (FIG. 3B), a Collection Palette 220 for a collection of men's clothes (FIG. 3C) and a Collection Palette 230 for a collection of babies' clothes (FIG. 3D). As shown in FIGS. 3A-3D, the collection palettes include differing colors and numbers of colors as are present in the various online catalogs.

As noted above, the Color Swatch Toolbox system 10 includes the Color Search Algorithm. One goal of the Color Search algorithm is to find an object or objects within a collection based on a query color. In one embodiment, the query color is chosen by entering RGB values (or coordinates from any other color space) in an interface such as a graphical user interface provided by the server 30 to the consumer operating one of the client devices 20. In another embodiment, a color “picker” tool is used to select a color from a range of exemplary colors presented to a consumer via the graphical user interface. One drawback seen by the inventors in permitting use of a color picker tool is that by allowing consumers to freely choose the query color, a search may yield no returned results. That is, if the query color is not in the collection to be searched, no objects within the collection are returned. Indeed, depending on the size of the collection, the likelihood of a consumer choosing a color that is actually present in one of the objects of the collection can be low. Therefore, in one embodiment described below, colors known to be within the collection palette (e.g., extracted colors using the Collection Palette Algorithm described above) are presented to the consumer for selection of the query color.

Once the query color has been chosen, the Color Swatch Toolbox system 10 looks for images within the collection that contain that query color or a color close enough (within a predetermined range of accuracy). In one embodiment, the resulting images are ordered by decreasing order of similarity of the query color to the closest color as compared to the query color that was found in the collection image. Results are represented on a display device such as a display monitor of a personal computer (e.g., one of the client devices 20) operated by the consumer together with the photo palettes of each photo. In one embodiment, color queries can be combined so as to search for objects that contain a combination of query colors, or colors close enough (within predetermined range of accuracy) to those query colors. Finally, query colors can be extracted from an image that is sent to the system by means of, for example, an image upload process.

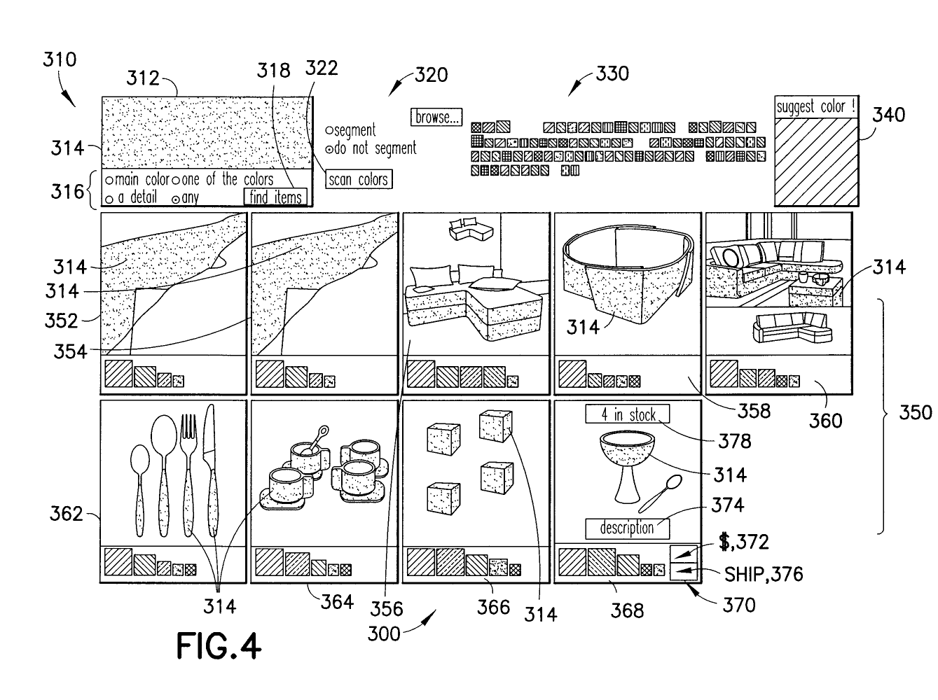

FIG. 4 depicts one embodiment of a user interface 300 provided by the Color Swatch Toolbox system 10. The user interface 300 is utilized by a prospective consumer operating one of the client devices 20. The consumer chooses to search an online collection for items of merchandise matching an inputted color selection. As shown generally at 310, the interface 300 includes a portion for initiating a search. The portion 310 includes a Select a Color input section 312. At the Select a Color section 312, the prospective consumers enters or confirms the search or query color 314 and indicates a preference 316 for where the color 314 should be located on an item of merchandise. For example, in one embodiment, the preference 314 may be a main color of the merchandise, one of the colors present in the merchandise, a color of a detail of the merchandise, or any of the above. In one embodiment, the search initiation portion 310 also includes an image upload portion 320 such that the consumer may load an image including a desired color. Once the image is loaded, the photo palette algorithm may execute (once invoked at 322) to identify colors or a dominant color in the image to be used as the query color(s) 314. Alternatively, the prospective consumer may select a color from a collection palette 330 derived for the collection or collections of interest. As noted above, by choosing a color or colors from the collection palette 330, at least one object of merchandise will be found from within the collection, which may not be the case when colors are uploaded and then searched. Once initiated, the search results are provided by means of a display or presentation 350 of items of merchandise with the collection that match the query color 314 and preference 316. In one embodiment, a Suggestions portion 340 of the interface 300 includes an area where a recommendation or suggestion of popular or trendy colors can be provided from the system 10 to the prospective consumers. The Suggestions portion 340 may be used, for example, by a retailer to feature a particular color within the collection such as during a promotional or other event of interest.

As shown in FIG. 4, the search results 350 include, for example, photo palettes 352, 354, 356, 358, 360, 362, 364, 366 and 368 extracted from the collection of items having colors that match the inputted query color 314 and the preference 316. For example, a bright orange color is selected as the query color 314 with the preference 316 set to “any” such that if the query color is found anywhere in an image in the collection, that image is returned in the search results. Accordingly, as shown in FIG. 4, a number of diverse items within the catalog are retrieved that have the query color 314 including sheets 352 and 354, furniture 356, 358, 360 and 366, and houseware such as utensils 362, cups 364 and a specialty server 368. To assist a prospective consumer, in one embodiment, other information 370 including for example, such as pricing 372, product descriptions 374, availability 378, shipping 376 and the like, may be provide as search results 350 accompanying the photo palettes, e.g., palette 368.

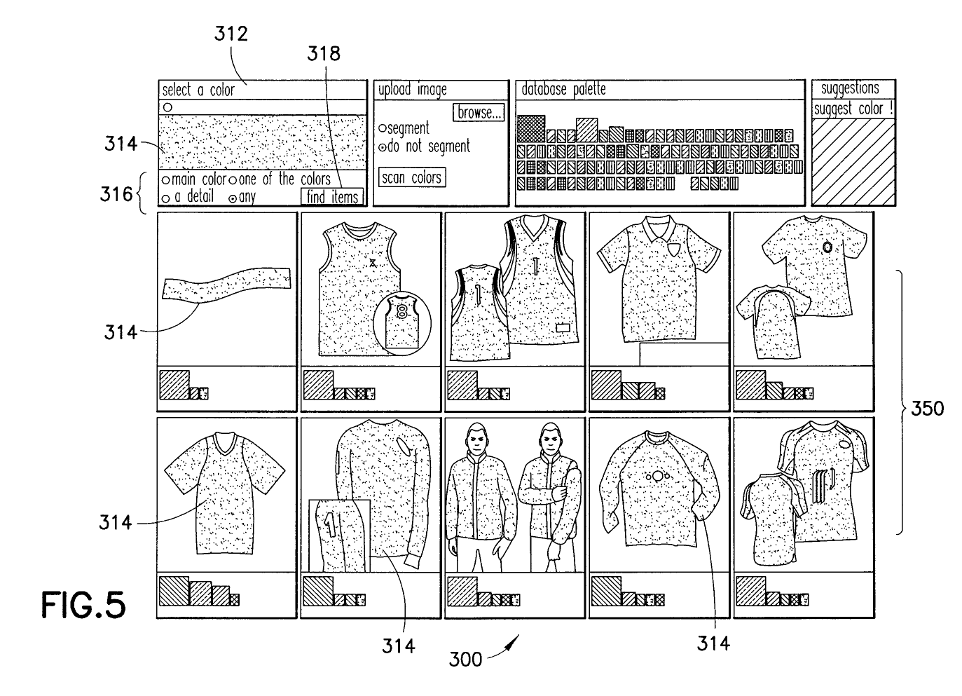

FIG. 5 depicts one embodiment of the user interface 300 provided by the Color Swatch Toolbox system 10 and utilized by a prospective consumer searching for one or more matching articles of clothing such as sports gear. The consumer initiates a search by selecting or entering the desired query color 314 in Select a Color section 312 and indicates a preference 316 for where the color 314 should be located on the sports gear. Once initiated by invoking Find Items 318 functionality, the search results 350 are provided. As shown in FIG. 5, the search results 350 include, for example, photo palettes extracted from the sports gear collection of items having colors that match the inputted query color 314 and the preference 316.

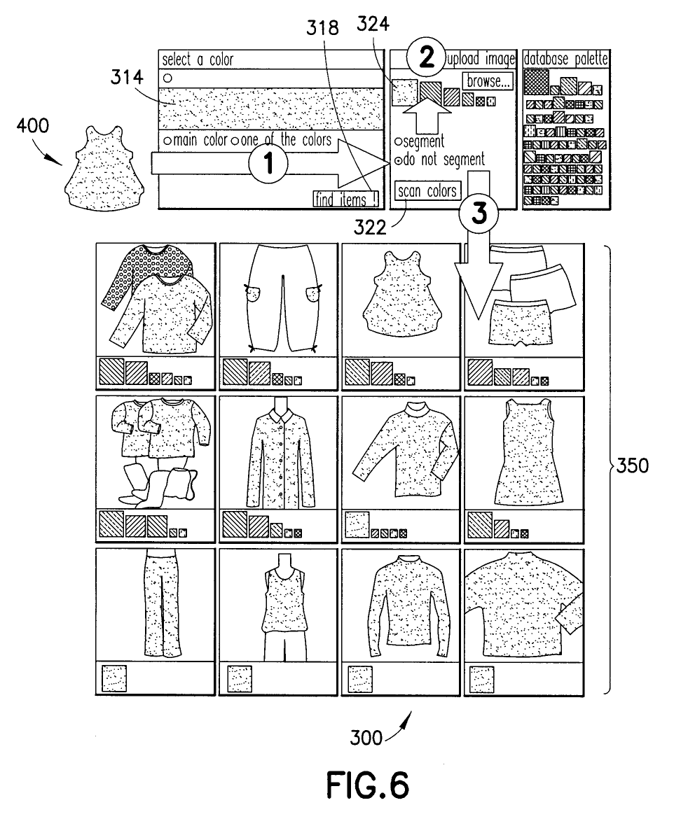

FIG. 6 depicts use of the user interface 300 wherein the upload image section 320 is utilized to upload an image 400 from which the query color 314 is selected. As shown in FIG. 6, a location of the image 400 is entered (indicated by “Arrow 1”) into the upload image section 320 and the photo palette algorithm is invoked at 322 (indicated by “Arrow 2”) to identify colors or a dominant color 324 in the image. One or more of the identified colors is selected as the query color(s) 314 and the Find Items functionality 318 is invoked to locate the items of the subject collection having the inputted query color(s) 314 and preference 316 (indicated by “Arrow 3”). As noted above, the search results 350 include, for example, photo palettes extracted from a collection of clothing items having colors that match the inputted query color(s) 314 and the preference 316.

In one embodiment, the Color Swatch Toolbox system 10 includes the aforementioned Matching Palette Algorithm. The Matching Palette Algorithm extracts all colors that are present in the items (e.g., clothing and portions thereof) found using the Color Search Algorithm. As such, colors matching the at least one query color are identified on the objects within the collection and the colors are presented and/or recommended to the consumer to facilitate further searching.

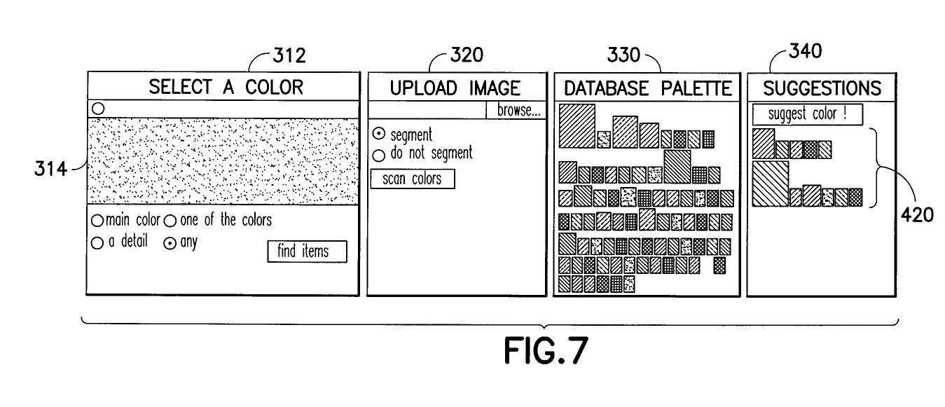

In one embodiment, a collection of images is taken from, for example, an online retailer's catalog. As shown in FIG. 7, the query color 314 is selected that is either a user defined color from the collection palette 330 or a color extracted from an uploaded image (entered via the upload image section 320). The Matching Palette Algorithm finds colors that match the query color 314 within the collection. That is, the query color 314 is used to retrieve all images that contain the query color 314 or a color close enough to the query color (e.g., within a predetermined range of accuracy). The colors of the search results 350 (e.g., the photo palette of all the retrieved images) are placed into a first color set. The first color set is simplified and clusterized using the Collection Palette Algorithm, as described above, to form a second or resulting color set 420. The resulting color set 420 represents the colors that are the most associated with the query color 314 within the subject collection and, thus, are included in the Suggestions portion 340 of the interface 300 to assist further searching. For example, the resulting color set 420 is used as suggestions for finding matching or complimentary colors to the originally inputted query color 314 that have already been located within the collection. As such, the Suggestions portion 340 can be used by prospective consumers to locate new items having color(s) that match a color(s) of or within an already purchased item. In one embodiment, as described above, colors from the already purchased item may be inputted by uploading a picture of the item such that a prospective consumer can locate new items that match or are complimentary to an item that was previously purchased.

In these ways, the present invention provides an improved experience in online shopping at least in that visual color sensations are provided to online consumers in a user-friendly manner.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A computer executed method for identifying a plurality of products within a collection of products in an online shopping environment, the method comprising:
providing a collection of images representing the collection of products offered for sale;
receiving an input search criteria from a prospective consumer, the input search criteria including at least one query color;
identifying and extracting colors within the collection of images based on a presence of significant colors in an image;
comparing and matching the query color to the identified and extracted significant colors;
determining, within a predetermined range of accuracy, products from within the collection of images having the matched query color; and
presenting the determined products to the prospective customer.

2. The method of claim 1, wherein the input criteria further includes a preference for where the query color appears on or within the image of the product.

3. The method of claim 1, wherein the at least one query color is retrieved from an uploaded image.

4. The method of claim 1, wherein the extracted significant colors in the collection of images are provided as recommendations for the at least one query color.

5. The method of claim 1, wherein the determined products are presented to the prospective consumer in an interface including the product image, the significant colors within the image and for each significant color a representation of a dominance of the significant color within the image.

6. A system for identifying a plurality of products within a collection of products in an online shopping environment, the system comprising:
a collection of images representing the collection of products offered for sale;
an interface including an input search criteria portion that receives at least one query color;
a collection palette processor for identifying and extracting colors within the collection of images based on a presence of significant colors in an image;
a color search processor for comparing and matching the query color to the identified and extracted significant colors, and for determining, within a predetermined range of accuracy, products from within the collection of images having the matched query color; and
a display device coupled to the color search processor for presenting the determined products to the prospective customer.

7. The system of claim 6, wherein the input search criteria portion further includes a portion for receiving a preference indicating where the query color appears on or within the image of the product.

8. The system of claim 6, wherein the interface further includes a portions for initiating an upload of an image and extraction of the at least one query color from the uploaded image.

9. The system of claim 6, wherein the interface further includes a recommendation portion wherein previously extracted significant colors in the collection of images are provided as recommendations for the at least one query color.

10. The system of claim 9, wherein the determined products are presented to the prospective consumer on the interface.

11. The system of claim 10, wherein the presentation of the determined products includes the product image, the significant colors within the image and a representation of a dominance of the significant color within the image.
